(19) United States
(12) Patent Application Publication
(10) Pub. No.: US 2010/0294610 A1
(43) Pub. Date: Nov. 25, 2010

(54) Fluid-Filled Clutch Arrangement

(76) Inventors: Michael Heuler, Wurzburg (DE); Jürgen Dacho, Bad Kissingen (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/786,116

(22) Filed: May 24, 2010

Related U.S. Application Data
(62) Division of application No. 11/732,990, filed on Apr. 5, 2007, now abandoned.

(30) Foreign Application Priority Data
Apr. 7, 2006 (DE) 10 2006 016 417.2
Feb. 7, 2007 (DE) 10 2007 005 999.1

(51) Int. Cl. F16D 25/062

(52) U.S. Cl. 192/58.2

(57) ABSTRACT

A fluid-filled clutch arrangement includes a housing; a piston mounted with freedom of axial movement in the housing, the piston being sealed against the housing, the piston having a drive side bounding a drive side pressure space from a takeoff side bounding a takeoff side pressure space; a clutch which can establish and release a working connection between a drive and a takeoff as a function of the position of the piston relative to the clutch; and a partition wall bounding the takeoff side pressure space opposite the piston, the partition wall being active between the takeoff side pressure space and a cooling space. At least one supply line connects a fluid supply source to at least one of the drive-side pressure space, the takeoff side pressure space, and the cooling space.

### CROSS REFERENCE TO RELATED APPLICATIONS

This application is a divisional of U.S. patent application Ser. No. 11/732,990 which was filed with the U.S. Patent and Trademark Office on Apr. 5, 2007. Priority is claimed for this invention and application, corresponding application(s) having been filed in Germany on Apr. 7, 2006, No. 10 2006 016 417.2, and Germany on Feb. 7, 2007, No. 10 2007 005 999.1, respectively. The entire contents of the above-mentioned applications are expressly incorporated herein by reference.

### BACKGROUND OF THE INVENTION

1. Field of the Invention

The invention pertains to a fluid-filled clutch arrangement for installation between a drive and a takeoff, including a piston mounted with freedom of axial movement in the housing, the piston being sealed against the housing and separating a drive side pressure space from a takeoff side pressure space; a clutch which can establish and release a working connection between the drive and the takeoff as a function of the position of the piston relative to the clutch; and at least one supply line connected to a fluid supply source and to at least one of the pressure spaces and a cooling space.

2. Description of the Related Art

DE 103 47 782 A1 describes a fluid-filled clutch arrangement in the form of a hydrodynamic torque converter, which has a clutch device, realized as a bridging clutch for a hydrodynamic circuit. The clutch device is installed in a housing. The clutch device is provided with a piston, which, as a function of its position in the housing, is able either to exert pressure on a clutch element of an axially adjacent clutch with a friction area, thus enabling the clutch to transmit some or all of the torque, or to release the pressure on the clutch element and thus to interrupt the transmission of the torque. Because a drive-side clutch element carrier of the clutch is connected via the housing to a drive (not shown) and a takeoff-side clutch element carrier of the clutch is connected via a torsional vibration damper to a takeoff in the form of a gearbox input shaft, the clutch device serves to connect and to disconnect the takeoff from the drive.

The piston is sealed off both at its radially outer end and at its radially inner end against the adjacent component and thus separates a drive-side pressure space provided between a drive side of the piston and an adjacent housing wall from a takeoff-side pressure space, in which the clutch is installed, provided on a takeoff-side of the piston. This takeoff-side pressure space thus serves as a cooling space for the clutch but is also in direct flow connection with the hydrodynamic circuit. The drive-side pressure space is connected to a supply source by a first supply line, whereas the takeoff-side pressure space is connected to the source by way of a second supply line, and the hydrodynamic circuit by way of a third supply line. In professional circles, this type of fluid-filled clutch arrangement is called a “three-line system”.

In the known fluid-filled clutch arrangement, the attempt is made to improve the necessary flow of fluid through the clutch, which must be cooled—this cooling process involving an exchange of fluid between the hydrodynamic circuit and the takeoff-side pressure space—by encapsulating the torsional vibration damper on the drive side. Even when this is done, however, there remain many gaps, which act as contact-free sealing points. For tolerance reasons, the size of these gaps may not fall below a certain minimum value, and as a result there are still many possibilities for the fluid medium to find ways to leak out undesirably. If, instead of the previously mentioned gaps, contact seals were to be used, these would be subject to increased wear as a result of friction precisely at the points of relative movement. This wear would lead in turn to an increase in the leakage flows. In addition, the quality with which the torsional vibration damper can isolate vibrations would also be significantly impaired as a result of friction. Nor can it be excluded that, as a result of undesirable leakage flows precisely in the takeoff-side pressure space, both the actuation speed of the piston and the quality of its control function could be negatively affected.

The previously described disadvantages apply in similar fashion to the fluid-filled clutch arrangements in the form of wet-running clutch systems which must operate without a hydrodynamic circuit capable of transmitting torque, but in which the clutch elements of the clutch are installed similarly in a cooling space, which is separated from a drive-side pressure space by a piston. Here, too, the pressure space is connected to a first supply line, and the cooling space is connected to at least one additional supply line. Examples of these types of clutch arrangements can be found in US 2006/0163023.

### SUMMARY OF THE INVENTION

The invention is based on the task of designing a fluid-filled clutch arrangement with a clutch device equipped with a piston in such a way that leakage flows of fluid medium which decrease cooling efficiency as well as undesirable frictional effects which impair the quality of vibrational isolation are both effectively avoided.

According to the invention, a partition wall is assigned to the takeoff-side of a piston of a clutch device of a fluid-filled clutch arrangement, so that the boundaries of a takeoff-side pressure space are formed on one side at least essentially by the takeoff-side of the piston and on the other side by the partition wall, which for its own part acts between the takeoff-side of the takeoff-side pressure space and a cooling space, which acts as a hydrodynamic circuit when the clutch device is designed as a hydrodynamic torque converter. As a result, the path along which the flow is guided is free of leakage-causing interruptions such as gaps in the radial area of the takeoff-side pressure space. In the area of the radial part of the takeoff-side pressure space, therefore, essentially all of the fluid flows from a supply line assigned to the takeoff-side pressure space, this line being connected to a supply source, and the clutch of the clutch device, which cooperates with the piston and has a friction area. This is true not only for the fluid flow from the supply line to the friction area but also for the flow in the opposite direction. In the case of a fluid-filled clutch arrangement in the form of a three-line system, the takeoff-side pressure space is connected directly to the supply line assigned to this pressure space, whereas, in the case of a fluid-filled clutch arrangement in the form of a two-line system, the takeoff-side pressure space can be connected to a supply line assigned to the drive-side pressure space by way of at least one connection to a drive-side pressure space. So that the two supply lines can be distinguished from each other more easily, the supply line assigned to the drive-side pressure space is to be called the “first” supply line, and the supply line assigned to the takeoff-side pressure space is to be called the “second” supply line.

Because of the previously mentioned design of the takeoff-side pressure space, fluid medium which flows through this pressure space can leave the pressure space on the side facing away from the supply line in question only via a flow passage, which connects the takeoff-side pressure space to the cooling space, as a result of which the fluid is forced to flow through the clutch of the clutch device and thus across its friction area. This advantage is obtained both in the case of a three-line converter and in the case of a two-line converter, where, in the latter case, the partition wall assigned to the piston offers the additional advantage of better control sensitivity in push mode; that is, the piston can be closed during operation in push mode in such a way that the engine can be used more efficiently as a brake.

Because of the partition wall, the takeoff-side pressure chamber is not only closed, except for the supply line and the flow passage, but also compact, which means that this pressure chamber can be filled more quickly with fluid and the pressure can be built up more quickly on the takeoff-side of the piston. The pressure chamber can also be filled in such a way that that the movement of the piston can be controlled with considerable sensitivity.

The partition wall itself can have freedom of axial movement relative to the piston, as a result of which the advantage is obtained that, regardless of the operating state of the clutch device at the moment in question, that is, regardless of whether it is open or closed or at least partially closed, the partition wall always remains pressed against the adjacent clutch element, as long as the fluid is flowing in the proper direction in the fluid-filled clutch arrangement. In this way, residual leakage is avoided, i.e., the leakage which could result if the partition wall were to become separated from the adjacent clutch element.

It can also be advantageous, however, for the partition wall to be permanently connected to the piston. Although the partition wall will therefore follow the movement of the piston during the opening of the clutch device and move away from the adjacent clutch element, this and the resulting residual leakage do not have a negative effect, because, when the clutch device is open, there is usually no frictional heat being developed. Simultaneously, because of its permanent connection to the piston, the partition wall, which, as will be described below in greater detail, can be mounted by means of an antitwist device in the housing of the fluid-filled clutch arrangement, has the effect of providing a nonrotatable mounting of the piston. The piston is thus secured against undesirable rotation relative to the housing and thus relative to any piston seals which may be present, which helps to reduce the wear on the seals. This permanent connection is preferably produced by welding or riveting, and it is especially preferable to provide it in the area of spacers, which are provided on the piston and/or on the partition wall, pointing in each case toward the other component, and which serve to create flow channels between the piston and the partition wall. Profiling can also be provided on the piston and/or on the partition wall for the same purpose.

The advantage achieved by a permanent connection to the partition wall, i.e., the advantage that the piston is prevented from twisting with respect to the housing, is also obtained by means of an axial slide guide between the piston and the partition wall, which, although it prevents relative rotation between the piston and the partition wall, allows relative axial movement between the piston and partition wall. An axial slide guide of this type is preferably provided in the radially central areas of the piston and partition wall and has pins or cassettes, which engage in assigned openings or cassette holders.

Through the previously mentioned antitwist measures for preventing the partition wall from turning with respect to the drive, a nonrotatable connection is established with the drive. In this way, it is ensured that the partition wall and the adjacent clutch element of the clutch will rotate at the same speed, which has a wear-reducing effect. By providing the partition wall in the area of its radially outer end with a radial shoulder, which is functionally equivalent to a clutch element, it is also becomes possible to eliminate the clutch element situated closest to the piston of the clutch device. Both in the case of this equivalent clutch element and in the case of a partition wall without a radial shoulder, the antitwist function can be provided by a set of teeth, especially in the area of the radially outer end of the partition wall. This set of teeth engages with another set of teeth, which serves to carry along the clutch element of the clutch attached nonrotatably to the drive. Alternatively, however, the partition wall could also be positively connected for rotation in common to a clutch element mounted nonrotatably on the housing cover.

An advantageous embodiment of the partition wall is obtained by designing this wall to act as an axial spring, which presses the piston elastically toward the housing cover, so that the production of an unintended, especially of an uncontrolled, working connection between the drive side and the takeoff-side of the clutch arrangement is avoided. An uncontrolled production of the working connection can occur in particular when the engine is started while the drive-side pressure space is already essentially filled but the hydrodynamic circuit is only partially filled. In this situation, the fluid is pushed radially outward by centrifugal force, and the air present essentially only in the hydrodynamic circuit acts in opposition to the fluid in the pressure space. In this operating state, sufficient pressure cannot be built up in the hydrodynamic circuit to counteract the pressure in the pressure space.

When an axial gap is formed between the partition wall designed as an axial spring and the piston of the bridging clutch, the partition wall acts as a mediating contact spring for the piston, thus allowing the working connection between the drive side and the takeoff-side of the clutch device to be established gently, without abrupt jumps in torque. The partition wall in this design works under load like a disk spring, in that the area which extends between the point where it is supported axially against the piston and the pressure area of the piston, preferably formed by a profiling provided thereon, undergoes elastic deformation. As the partition wall continues to undergo elastic deformation, the axial gap will eventually be completely closed. At this point, the piston will work together with clutch again without any spring-loaded contact behavior, in the same way as that described for the previously explained embodiment.

The partition wall preferably has at least one integrated zone, which is provided in at least one predetermined radial area relative to the axis of rotation of the clutch. When profiling is provided on the pressure area of the piston, this zone can be flat, but it can also be provided with its own profiling, so that flow channels are formed for the fluid flowing in the radial direction. In the latter case, the pressure area of the piston can be flat. The previously mentioned profiling can be designed either as wave-like profiling or as interrupted profiling. In the former case, the axial distance of the partition wall from the piston changes in alternating fashion in the circumferential direction, whereas, in the latter case, tongues are provided on the partition wall, which extend radially outward, the circumference being interrupted by these tongues.

Profiling can be provided both on an axially rigid partition wall and on a partition wall designed to function as an axial spring.

The partition wall guides the fluid medium present between it and the piston of the bridging clutch radially outward into the area of the clutch. There, the required flow passages for the fluid medium are present between the tip areas of an inner set of teeth on an axial section of the housing and the root areas of an outer set of teeth on radially outer clutch elements and on a final clutch element serving for axial support. The fluid medium is therefore able to arrive at the individual clutch elements. To prevent the fluid medium from bypassing the clutch elements, that is, to prevent it from passing by the direct route from the partition wall via the flow passages into the hydrodynamic circuit, a back-up ring, which positions the previously mentioned last clutch element in the axial direction, is used as a fluid seal. The back-up ring is therefore preferably located axially between the flow passages and the hydrodynamic circuit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a schematic diagram of a drive train with a drive, a fluid-filled clutch arrangement, and a gearbox arrangement;

FIG. 2 shows a longitudinal cross section of the clutch arrangement, with a clutch device equipped with a piston, a partition wall, and a clutch, and with the formation of three supply lines;

FIG. 3 shows a detail of the piston and partition wall with through-rivets as a form of connection, the assembly being mounted on a torsional vibration damper;

FIG. 4 is similar to FIG. 3 but shows an arrangement of a piston and partition wall on a drive-side housing hub together with a seal in the form of a gap seal assigned to the partition wall;

FIG. 5 is similar to FIG. 4 but shows a seal in the form of a contact seal;

FIG. 6 shows a plan view of a clutch element of the clutch;

FIG. 7 shows a plan view of the partition wall;

FIG. 8 shows a detail with the antitwist function established between the partition wall and a clutch element of the clutch;

FIG. 9 shows a piston antitwist function achieved by mounting the piston on an axial slide guide of the partition wall;

FIG. 10 shows a plan view of the partition wall to illustrate another type of axial slide guide;

FIG. 11 shows a design of the partition wall which can serve as a clutch element of the clutch;

FIG. 12 shows the centering of the piston on the drive-side housing hub and of the partition wall on the torsional vibration damper, a bearing also being installed between the housing hub and the torsion damper hub;

FIG. 13 is similar to FIG. 2 but shows a design of the clutch arrangement with two supply lines;

FIG. 14 is similar to FIG. 2 but shows a design with the partition wall as an axial spring resting directly against the piston;

FIG. 15 is similar to FIG. 14, but shows an axial gap between the partition wall and the piston, the working connection between the drive and the takeoff thus being interrupted;

FIG. 16 shows an enlarged detail of an area of FIG. 15;

FIG. 17 shows a diagram of the partition wall with wave-like profiling;

FIG. 18 is similar to FIG. 17 but shows an interrupted profiling of the partition wall;

FIG. 19 shows a view of a set of teeth, already seen in FIG. 2, looking toward the piston from a point between two radially outer clutch elements;

FIG. 20 is similar to FIG. 19, but looking here toward the side of a back-up ring facing away from the radially outer clutch plates, the back-up ring serving to position a last clutch element with respect to a set of teeth in the housing; and

FIG. 21 is similar to FIG. 18 but also shows the antitwist device.

### DETAILED DESCRIPTION OF THE PRESENTLY PREFERRED EMBODIMENTS

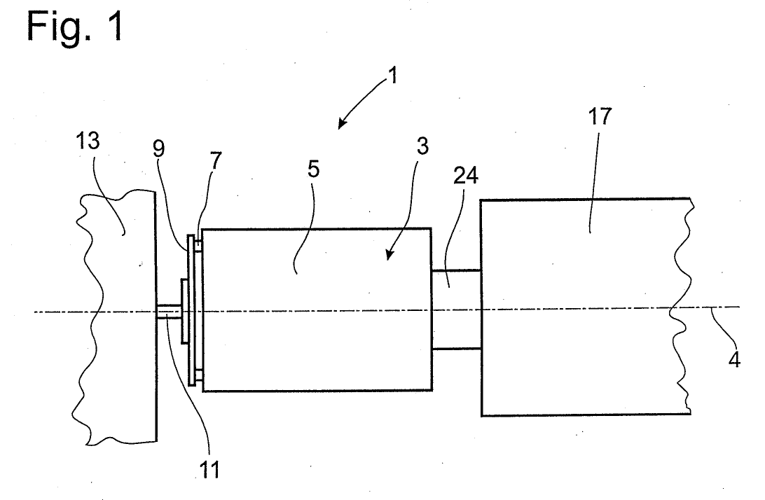

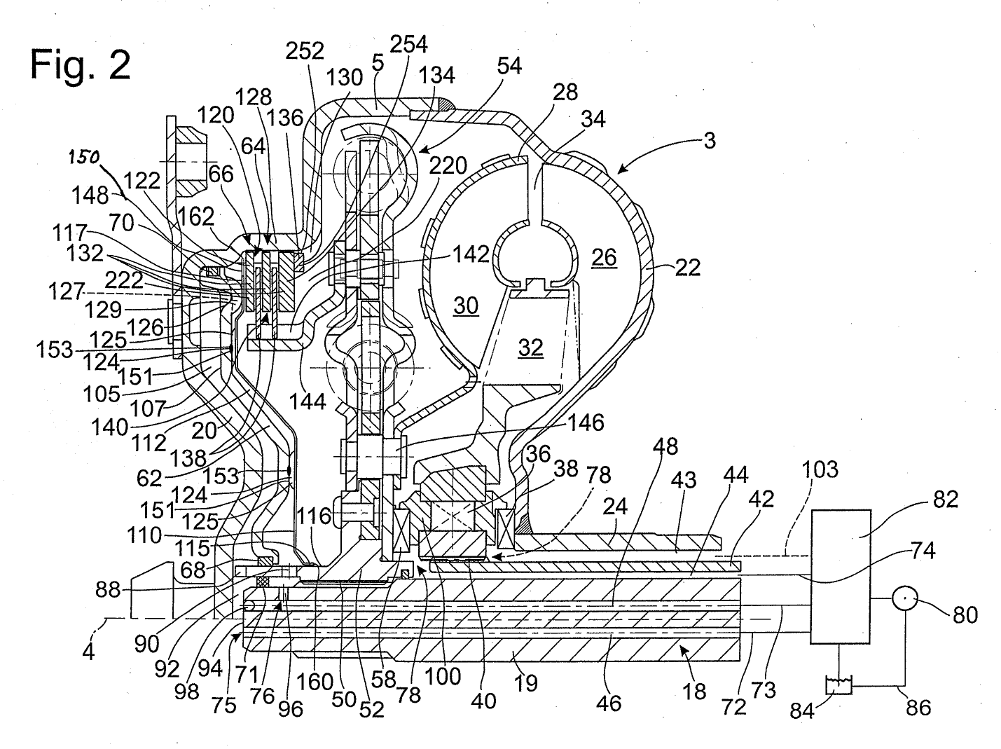

FIG. 1 shows a schematic diagram of a drive train 1 with an inventive, fluid-filled clutch arrangement 3 formed either by a hydrodynamic torque converter or by a wet-running clutch system such as that known from the previously mentioned DE 102 34 822 A1. The clutch arrangement 3, which can execute rotational movement around the axis of rotation 4, comprises a housing 5, which can be connected for rotation in common to a drive 11, such as the crankshaft of an internal combustion engine 13, by means of a plurality of fastening elements 7 and a connecting element 9 such as a flexplate. On the axial side facing away from the drive 11, the housing 5 has a takeoff-side housing hub 24, which, for example, engages in a gearbox arrangement 17 and there drives a fluid transport pump (not shown) in rotation. Concentric to the takeoff-side housing hub 24, a takeoff 18, shown in FIG. 2, is provided, which can be designed as a gearbox input shaft 19, for example. The free end of this shaft projects into the housing 5.

FIG. 2 shows the fluid-filled clutch arrangement 3 in the form of a hydrodynamic torque converter. On the side facing the drive 11, the housing 5 has a housing cover 20, which is permanently connected to a pump wheel shell 22. In the radially inner area, the shell merges into a pump wheel hub 24.

The pump wheel shell 22 and the pump wheel vanes together form a pump wheel 26, which cooperates with a turbine wheel 30, comprising a turbine wheel shell 28 and turbine wheel vanes, and with a stator 32 equipped with stator vanes. The pump wheel 26, the turbine wheel 30, and the stator 32 form a hydrodynamic circuit 34 in the conventional manner.

The stator 32 is mounted on a freewheel 36, which is supported axially against the pump wheel hub 24 by an axial bearing 38 permeable to the fluid medium and is connected nonrotatably but with freedom of relative movement in the axial direction to a support shaft 42 by means of a set of teeth 40. The support shaft is located radially inside the takeoff-side housing hub 24 and forms together with it a channel 43. The support shaft 42, designed as a hollow shaft, surrounds the gearbox input shaft 19, serving as the takeoff 18, to form an essentially ring-shaped channel 44. The gearbox input shaft has two axial passages 46, 48, offset from each other in the radial direction, for fluid medium. The first axial passage 46 leads to a deflection chamber 92 on the drive-side end 94 of the gearbox input shaft 19, whereas the second axial passage 48 terminates at a plug 98 shortly before reaching the drive-side end 94 of the gearbox input shaft 19 and then opens radially outward by way of a radial connection 96.

The axial passages 46, 48, like the channel 44 and/or the channel 43, are connected by flow lines 72-74 and/or 103 to a fluid distributor 82, which can be connected to a supply source 80 to receive fluid medium and to a reservoir 84, into which the fluid medium can be discharged. The latter can be connected to the supply source 80 by a connecting line 86.

The gearbox input shaft 19 has a set of teeth 50, by which it holds a torsion damper hub 52 of a torsional vibration damper 54 nonrotatably but with freedom of axial movement. The torsion damper hub 52 is supported on one side against the previously mentioned freewheel 36 by an axial bearing 58, and on the other side it can come to rest against the housing cover 20. The torsion damper hub 52, furthermore, carries a piston 62 of a clutch device 66, designed as a bridging clutch 64. The piston 62 is sealed off against the torsion damper hub 52 by a radially inner piston seal 68 and against the housing cover 20 by a radially outer piston seal 70.

On the radially inner side of the torsion damper hub 52, a seal 71 is provided, which is supported on the other side against the gearbox input shaft 19 and acts between the radial passages 88, 90 provided in the torsion damper hub 52. The drive-side radial passage 88 cooperates with the deflection chamber 92, the first axial passage 46, and the first flow line 72, to form a first supply line 75 for fluid medium, whereas the takeoff-side radial passage 90 cooperates with the radial connection 96, the second axial passage 48, and the second flow line 73 to form a second supply line 76. Finally, to form a third supply line 78, a flow passage 100 axially between the axial bearing 58 and the freewheel 36 cooperates with the channel 44 and the flow line 74, and/or a flow passage 102 axially between the freewheel 36 and the axial bearing 38 cooperates with the channel 43 and the flow line 103.

Fluid medium introduced via the first supply line 75 from the fluid distributor 82 arrives in a drive-side pressure space 105, located between the housing cover 20 and the piston 62. When there is positive pressure in this space, it acts on the drive side 107 of the piston 62. Fluid medium introduced via the second supply line 76 from the fluid distributor 82 arrives, in contrast, in a takeoff-side pressure space 112, located between the piston 62 and a partition wall 110, which is free to move axially relative to the piston. When there is positive pressure in this space, it acts on a takeoff side 114 of the piston 62.

The partition wall 110 can be designed with axial elasticity. It is centered by its radially inner end 115 on the torsion damper hub 52 by sealing 160, where this sealing 160 is designed as a gap seal 116. The radially outer end 117 of the partition wall 110 serves as an antitwist device 162, projecting axially into an area between the piston 62 and the first clutch element 122 of a clutch 120. So that the fluid medium can flow easily, the partition wall 110 is provided with spacers 124 on the side facing the piston 62. Between them, the spacers form first flow channels 125, which are distributed around the circumference and extend in the radial direction between the piston 62 and the partition wall 110. Alternatively or in addition, the piston 62 can be designed with nubs 126, so that, in this way, second flow channels 127 integrated into the piston 62 are obtained. As a result, a pressure area 129 is formed in the piston 62.

On the interior side of an axial section 128 of the housing cover 20, a set of teeth 130 is provided for the radially outer clutch elements 132, referred to in the following in brief as “outer clutch elements”, to which the previously mentioned first clutch element 122 and a last clutch element 134, which has a larger cross section and is therefore stiffer, belong. The latter element is supported axially on the housing cover 20 by a back-up ring 136. Because of the set of teeth 130, the outer clutch elements 132 are connected nonrotatably to the housing 5 and thus to the drive 11.

Under the action of the piston 62, the outer clutch elements 132 can be brought into working connection with the radially inner clutch elements 138, referred to in the following in brief as “inner clutch elements”, where a friction area 140 of a clutch 120 serving to transmit torque is created between the friction linings and friction surfaces of the clutch elements 132, 138. The inner clutch elements 138 are connected nonrotatably to an input part 146 of the torsional vibration damper 54 by way of a set of teeth 142 on a carrier 144. By means of this input part, the torque can be transmitted via the set of teeth 50 to the gearbox input shaft 19. Thus the inner clutch elements 138 are connected to the takeoff 18 by way of the torsional vibration damper 54. When the clutch elements 132, 138 are separated from each other, however, torque introduced by the housing 5 is transmitted via the hydrodynamic circuit 34 to the turbine wheel 30 and from that by means of a connection 146 to the torsional vibration damper 54, from which the torque in turn is transmitted onward to the gearbox input shaft 19 and thus to the takeoff 18. If a torsional vibration damper 54 is not provided, the inner clutch elements 138 can be connected directly to the takeoff 18 in either of the two operating states.

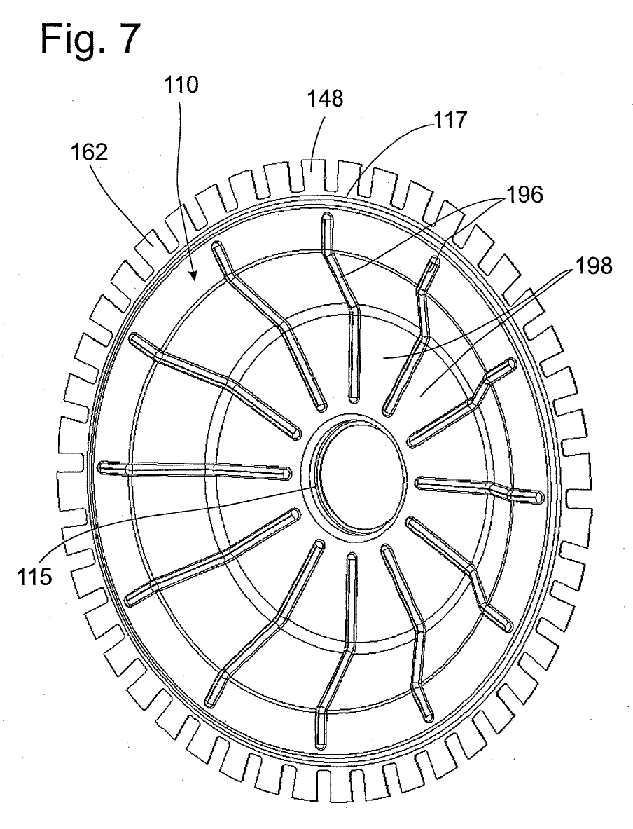

In regard to the partition wall 110 it only remains to be noted that, because of the engagement of its radially outer end 117 axially between the piston 62 and the first clutch element 122, it participates in the transmission of axial force from the piston 62 to the friction area 140 of the clutch 120. Preferably in this case the partition wall 110 is provided with axial elasticity and is therefore designed especially as a diaphragm-like element. In addition, the partition wall 110 can be connected nonrotatably to the set of teeth 130 of the outer clutch elements 132 by way of a set of teeth 148 on its radially outer end 117. FIG. 7 shows this set of teeth 148 very clearly.

To close the bridging clutch 64 and thus to engage it, positive pressure versus the takeoff-side pressure space 112 is built up in the drive-side pressure space 105 by way of the first supply line 75. As a result, the piston 62 and the partition wall 110 are both shifted toward the clutch 120 and thus exert an axial force on the clutch elements 132, 138. In this operating state, the partition wall 110 is thus pressed by the piston 62 against the first clutch element 122. Simultaneously, the takeoff-side pressure space 112 is being supplied with fluid medium through the second supply line 76 to cool the friction area 140 of the clutch 120. Thanks to the spacers 124 and/or the profiling 126, the medium flowing in from the second supply line 76 can travel radially outward via the flow channels 125, 127 in the pressure space 112 and then flow away via the set of teeth 148 of the partition wall 110 directly into the set of teeth 130 of the outer clutch elements 132. The set of teeth 148 thus acts as the only flow passage 150 for the fluid medium between the takeoff-side pressure space 112 and a cooling space 220, in which the clutch 120 is installed, so that, every time fluid medium passes between these two spaces 112, 220 of the fluid-filled clutch arrangement 3, the clutch 120 is subjected to the forced flow of the fluid. If the fluid-filled clutch arrangement 3 is designed as a hydrodynamic torque converter, the cooling space 220 acts simultaneously as the hydrodynamic circuit 34.

After entering the set of teeth 130 of the outer clutch elements 132, the fluid medium is conveyed axially onward within the toothed area, but it will never be conveyed farther than the axial area of the last clutch element 134 and/or of the back-up ring 136 as long as appropriate sealing measures have been taken on at least one of these components and/or in the area of the set of teeth 130. In this way, the only possibility remaining to the fluid medium is to flow radially inward through the friction area 140 of the clutch 120 between the clutch elements 132 and 138 into the cooling space 220, and as a result it cools the friction area 140 in a highly efficient manner.

From the cooling space 220, the fluid medium travels via the flow passage 100 and/or 102 and thus via the third supply line 78 back to the fluid distributor 82.

To open the bridging clutch 64 and thus to disengage it, the second supply line 76 and thus the takeoff-side pressure space 112 are subjected to positive pressure versus the drive-side pressure space 105, and thus the piston 62 is shifted toward the housing cover 20 to release the axial force transmitted to the clutch elements 132, 138. The supply of the takeoff-side pressure space 112 with fluid medium from the second supply line 76 has the effect that the partition wall 110 remains in contact axially with the first clutch element 122, whereas the piston 62 completes its shifting movement toward the housing cover 20. In this operating state as well, therefore, the set of conditions according to which the fluid medium can flow away only via the set of teeth 148 of the partition wall 110 from the takeoff-side pressure space 112 still remains in effect. The fluid thus immediately enters the set of teeth 130 of the outer clutch elements 132, so that the set of teeth 148 continues to act as a flow passage 150 for the fluid medium between the takeoff-side pressure space 112 and the hydrodynamic circuit 34.

While the bridging clutch 64 is being opened or after the bridging clutch 64 has been opened, the fluid medium will first, after entering the set of teeth 130 of the outer clutch elements 132, be conducted axially onward over at least a part of the toothed area. It will then flow away through the friction area 140 of the clutch 120, through the cooling space 220, and return to the fluid distributor 82 via the flow passage 100 and/or 102 and thus via the third supply line 78.

As a result of the partition wall 110, therefore, regardless of the operating state of the bridging clutch 64, it is ensured that the flow passage 150 will always represent the only flow connection at the time in question between the takeoff-side pressure space 112 and the cooling space 220, as a result of which a forced flow exclusively by way of the clutch 120 is created between these two spaces 112, 220 of the fluid-filled clutch arrangement 3.

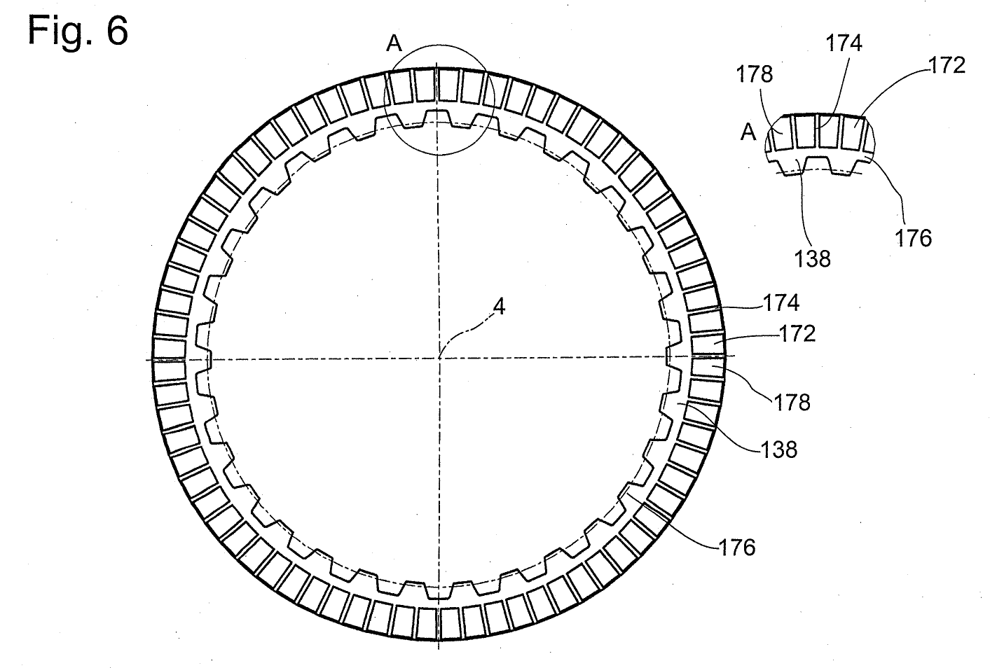

To ensure the trouble-free flow of the fluid medium through the friction area 140 of the clutch 120, grooves 174 are provided within the area over which the friction area 140 extends, preferably in the friction linings 172. FIG. 6 shows by way of example a friction lining 172 of this type, consisting of individual friction lining segments 178, which are mounted on a carrier plate 176 of one of the inner clutch elements 138 a certain distance apart from each other in the circumferential direction. In this way, the usable depth of the grooves 174 is equal to the full depth of the circumferentially adjacent friction lining segments 178. A design of this type, in combination with a sufficiently large number of grooves 174 of sufficient width, supports the flow without exerting any significant throttling effect. This is easy to accomplish, because the flow passage 150 already exerts a certain throttling effect between the takeoff-side pressure space 112 and the cooling space 220.

In a departure from the way in which the flow is guided in the variants described up to now, it is also possible, of course, when the bridging clutch 64 is being opened or after the bridging clutch 64 has been opened, for the fluid medium to be supplied from the fluid distributor 82 by way of the third supply line 78, so that the medium, after passing through the cooling space 220 and the clutch 120, arrives via the flow passage 150 in the takeoff-side pressure space 112. From there it flows radially inward and returns to the fluid distributor 82 by way of the second supply line 76. When this flow direction is chosen, of course, the pressure in the cooling space 220 will be higher than that in the takeoff-side pressure space 112, and this will result in the axial displacement of the partition wall 110 toward the piston 62 and thus the separation of the partition wall 110 from the adjacent first clutch element 122. This means that a gap 222 can form between the partition wall 110 and the first clutch element 122. As a result, there can be some residual leakage from the cooling space 220, in that the fluid can seep into the gap 222. Because the bridging clutch 64 is open, however, this does not have any negative effect, because the clutch 120 to be cooled is not being heated to any significant degree in the absence of friction. In spite of the gap 222, furthermore, most of the fluid flowing through the flow passage 150 will still arrive in the takeoff-side pressure space 112.

Because of this situation, it is possible to fasten the partition wall 110 to the takeoff-side 114 of the piston 62 by means of permanent connections 151. Then, although the partition wall 110 remains always a constant distance away from the position 62, it will form the previously mentioned gap 222 between the partition wall 110 and the adjacent first clutch element 122 when the piston moves away from the clutch 120. In the design according to FIG. 2, the permanent connections 151 can be achieved by tack welds 153, produced between the takeoff-side 114 of the piston 62 and the individual spacers 124 of the partition wall 110.

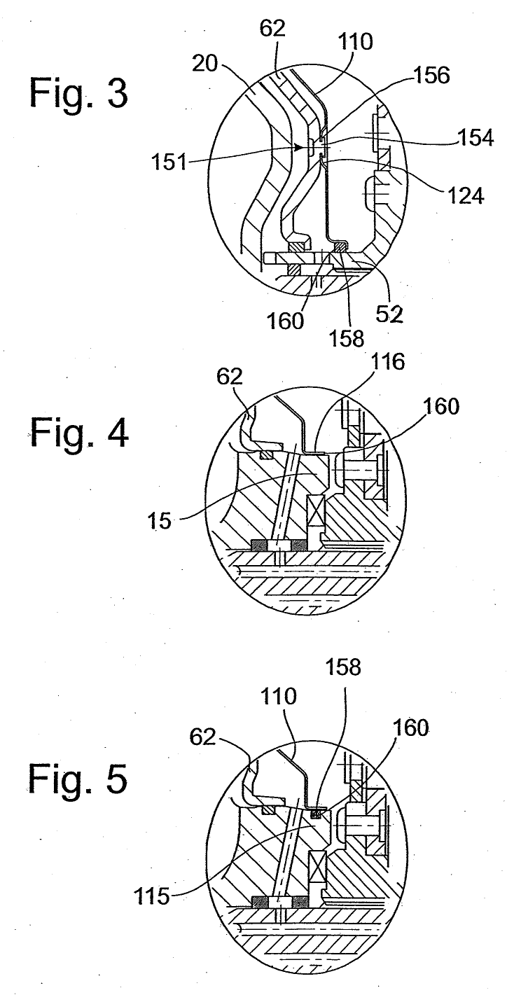

A permanent connection 151 in the area of each spacer 124 but produced by a different connection method is shown in FIG. 3, which illustrates only the radially inner area of the piston 62, the partition wall 110, and the torsion damper hub 52. According to this method, the piston 62 has through-rivets 154, which, after passing through openings 156 in the partition wall 110, are subjected to the counter-riveting movement and thus fasten the partition wall 110 to the piston 62.

FIG. 3 also shows a sealing 160 of the partition wall 110 against the torsion damper hub 52 by means of a contact seal 158, such as an elastomeric seal. A sealing 160 of this type can also be seen in FIG. 5. Here, however, the partition wall 110 is centered together with the piston 62 on the drive-side housing hub 15, and accordingly the sealing 160 is provided radially between the partition wall 110 and the drive-side housing hub 15. The sealing 160 can also be designed as a gap seal 116 at the exact same point, as shown in FIG. 4. This location has the advantage that the piston 62 and the partition wall 110 are not only mounted in the radially outward area on the housing 5 but also supported in the radially inward area. Because of the absence of differential rpm's, therefore, both the radially inner piston seal 68 and the sealing 160 assigned to the partition wall 110 are subjected to less stress than they would be if mounted on the torsion damper hub 52.

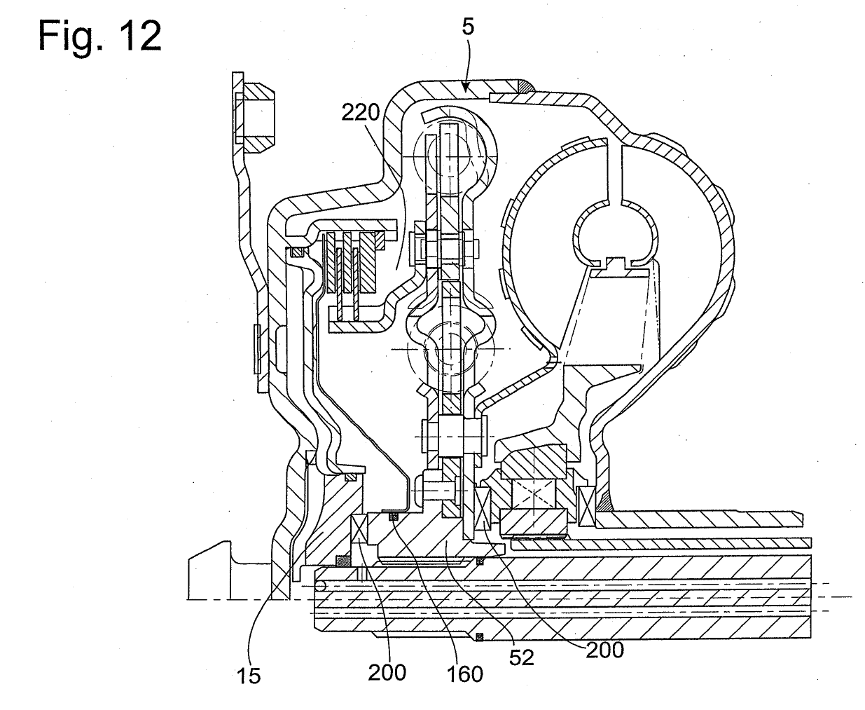

An arrangement similar to FIG. 4 or FIG. 5 is shown in FIG. 12, in which the piston 62 is centered in the same way on the drive-side housing hub 15, whereas the partition wall 110 is now centered on the torsion damper hub 52. To limit the higher load on the sealing 160 assigned to the partition wall 110 that might arise, a bearing 200 is provided between the drive-side housing hub 15 and the torsion damper hub 52; depending on the concrete design, this bearing can be a roller bearing or a friction bearing and, while acting in the radial and/or axial direction, can ensure that the gearbox input shaft 19 acts with less offset and less imbalance with respect to the housing 5.

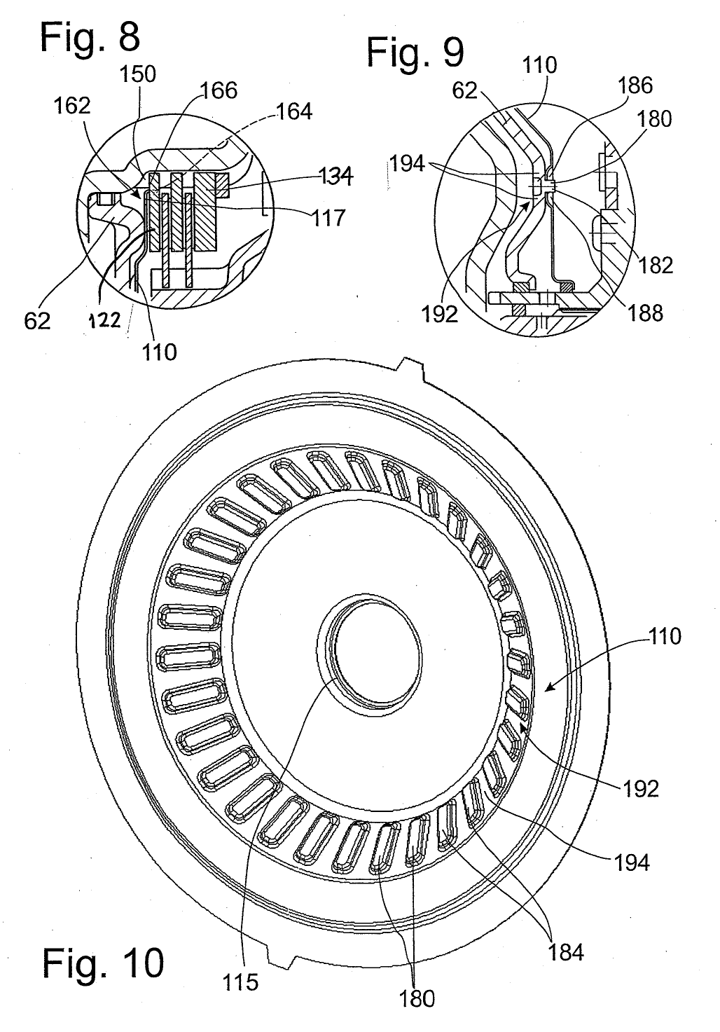

FIG. 8 shows an antitwist device 162 different from that of FIG. 2. Here the partition wall 110 is provided with projections 166 in the area of its radially outer end 117. These projections are offset from each other circumferentially and extend toward the adjacent first clutch element 122, so that they can then project into corresponding openings 164 in an at least essentially positive manner and in this way ensure that a connection for rotation in common is established with this first clutch element 122. Because the first clutch element 122, in the present design, is designed as an outer clutch element 132, the partition wall 110 is connected to the housing 5 and thus to the drive 11. The flow passage 150 in this design is situated radially outside the radially outer end 117 of the partition wall 110, and the set of teeth 130 of the housing cover 20 form the boundaries of its flow cross section.

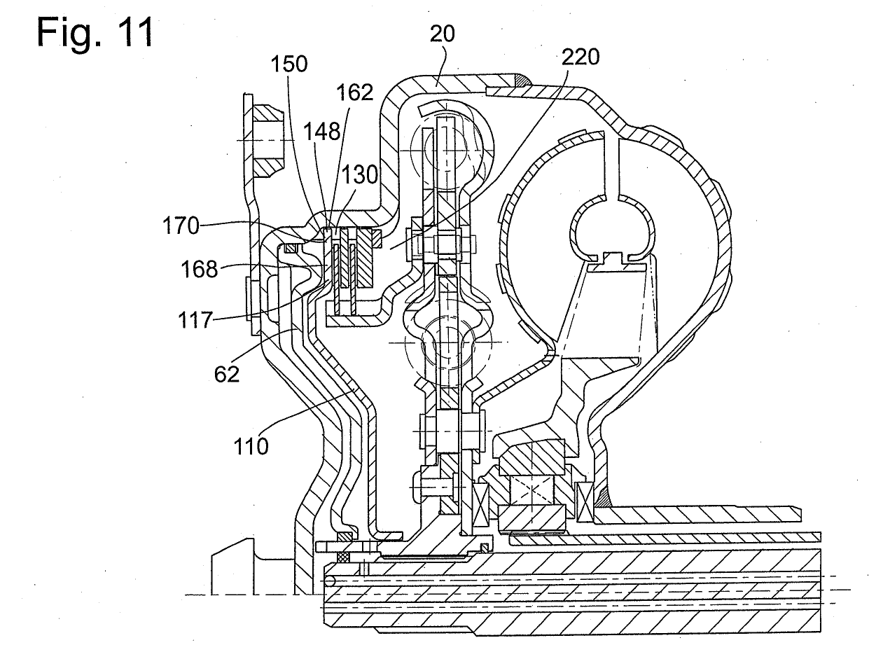

Another design of this type is shown in FIG. 11, where, in the area of its radially outer end 117, the partition wall 110 takes over the function previously performed by the first clutch element 122 through a radial shoulder 168 and thus acts functionally as an equivalent clutch element 170. The advantage to be derived here lies in the elimination of the first clutch element 122 as a separate component. To form the antitwist device 162, the set of teeth 148 is integrated into the radial shoulder 168 and engages in the set of teeth 130 of the housing cover 20. Thus, in this embodiment as well, the partition wall 110 is connected nonrotatably to the drive 11. The flow passage 150 is created, as also in the case of the embodiment according to FIG. 2, in the area of the set of teeth 148 in conjunction with the set of teeth 130 of the housing cover 20.

FIG. 9 shows an embodiment in which pins 182 distributed in the circumferential direction are provided on the piston 62. These pins extend toward the partition wall 110, and each one projects into an assigned opening 188 in the partition wall. The pins 182 thus form an axial slide guide 180, and together with the openings 188 acting as receptacles 186, they form a piston antitwist device 192 for the piston 62 which still allows relative movement in the axial direction between the piston 62 and the partition wall 110. The piston antitwist device 192 is preferably located in the radially central section 194 of the piston 62 and the partition wall 110.

Preferably in the same radial area but with a different design, FIG. 10 shows another piston antitwist device 192. In this device, axially projecting cassettes 184 are provided as axial slide guides 180 on the partition wall 110. Each cassette engages in an assigned cassette holder (not shown) serving as a receptacle in the piston 62.

FIG. 7 shows a plan view of the partition wall 110. In this diagram, the radial profilings 196 are very easy to see. A flow channel 198 is formed between each pair of circumferentially adjacent profilings. As a result, vortex formation between the piston 62 and the partition wall 110 promoted by the coriolis effect is at least reduced.

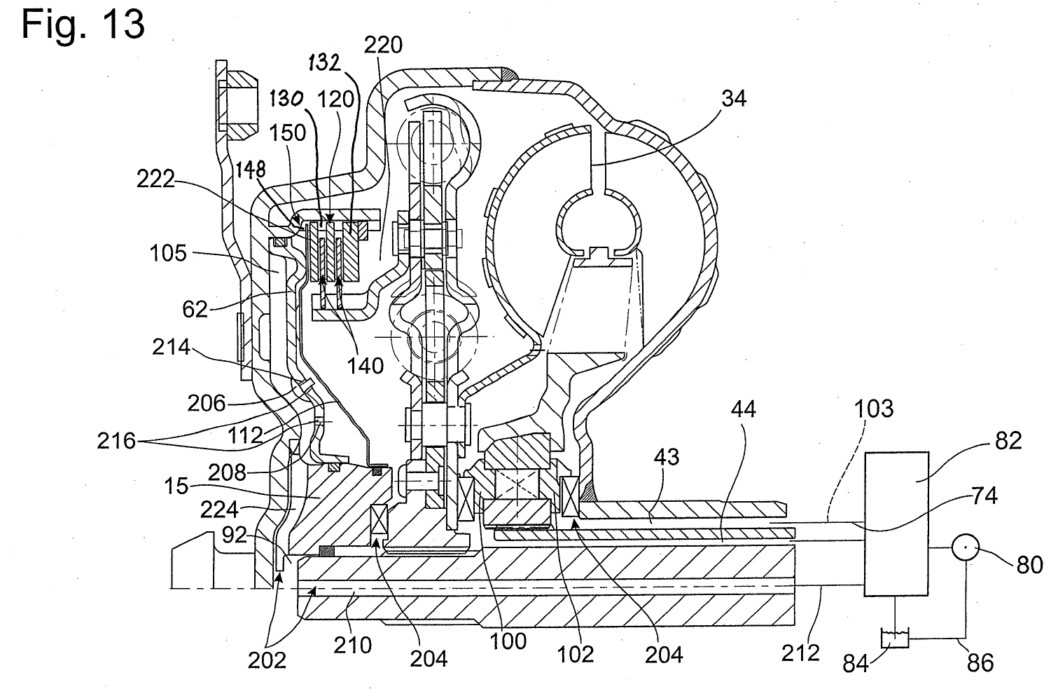

So far, only embodiments of the fluid-filled clutch arrangement 3 with three supply lines 75, 76, and 78 have been discussed, referred to in brief as “three-line systems”. In FIG. 13, however, a two-line system is presented, which has a second supply line 204 in addition to a first supply line 202. The first supply line 202 corresponds functionally to the first supply line with reference number 75 described on the basis of FIG. 2, whereas the second supply line 204 corresponds functionally to the third supply line with reference number 78 in FIG. 2, so that in this respect no further description appears necessary.

The only difference involves the flow route for supplying the takeoff-side pressure space 112 with fluid medium. When the bridging clutch 64 is closed, the fluid medium originates from the drive-side pressure space 105, namely, via a first connection 208, provided in the piston 62. This connection acts as part of a throttle 216 and thus allows only a limited volume flow rate to pass from the drive-side pressure space 105 into the takeoff-side pressure space 112.

The drive-side pressure space 105 is supplied by the fluid arriving from the fluid distributor 82 via the flow line 212, which is assigned to the first supply line 202 and which leads to the center bore 210 in the gearbox input shaft 19. The fluid then flows via the deflection chamber 92, also assigned to the first supply line 202, and arrives in the drive-side pressure space 105 from the deflection chamber via channels 224 in the drive-side housing hub 15. Because of the positive pressure present there in this operating state versus the takeoff-side pressure space 112, the fluid medium is conveyed from the drive-side pressure space 105 via a first connection 208 into the takeoff-side pressure space 112. In this operating state, a valve 206, which is integrated into the piston 62 and which controls a second connection 214 between the pressure spaces 105 and 112 and thus serves as another part of the throttle 216, is closed to block off the second connection 214.

The fluid medium which has thus arrived in the takeoff-side pressure space 112 then flows under the effect of centrifugal force radially outward within the pressure space 112, and from there it flows in the previously described manner via the flow passage 150 and the set of teeth 130 on the housing cover 20 as forced flow to the friction area 140 of the clutch 120. From there, after it has been used in the cooling space 220, it returns to the fluid distributor 82 via the second supply line 204.

So that the bridging clutch 64 can be at least partially opened or so that the bridging clutch 64 can be opened completely, the second supply line 204 is subjected to a positive pressure versus the drive-side pressure space 105, whereupon the fluid medium arrives via the clutch 120 and the set of teeth 130 assigned to the outer clutch elements 132 in the area over which the partition wall 110 extends. It then flows away via the set of teeth 148 on the partition wall serving as a flow channel 150 for the fluid medium into the takeoff-side pressure space 112. As a result of pressure in the takeoff-side pressure space 112, which is increasing versus the drive-side pressure space 105, the piston 62 is shifted toward the housing cover 20 and thus at least partially releases the axial force being transmitted to the clutch elements 132, 138.

Because of the positive pressure in the takeoff-side pressure space 112 versus the drive-side pressure space 105, the fluid medium present in the takeoff-side pressure space 112 is conveyed via the first connection 208 into the drive-side pressure space 105. Simultaneously, the positive pressure in the takeoff-side pressure space 112 causes the valve 206 to open, so that the second connection 214 assigned to it is also released. Fluid medium now flows at a greater rate via the connections 208 and 214 into the drive-side pressure space 105, from which it then returns to the fluid distributor 82 via the first supply line 202.

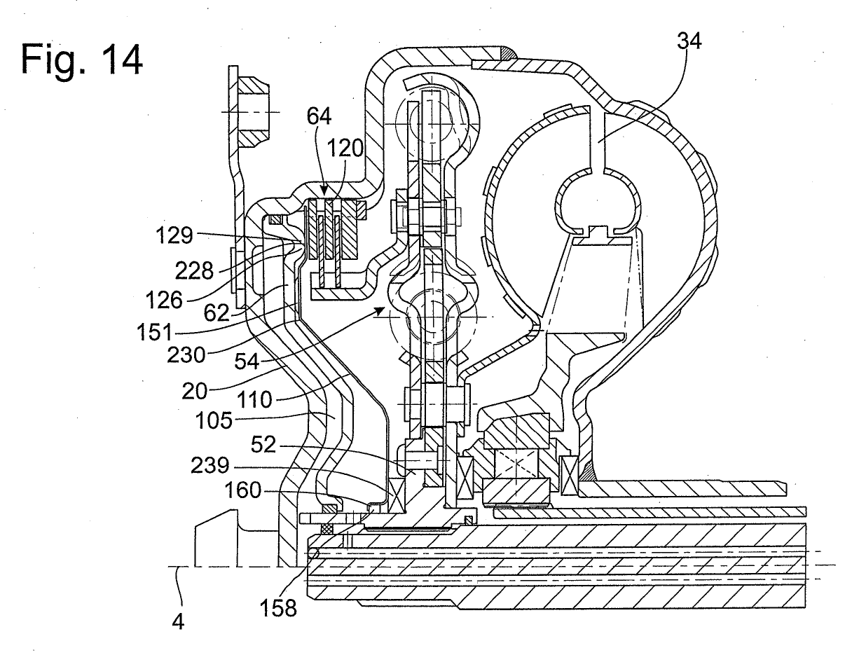

FIG. 14 shows a partition wall 110, which is designed as an axial spring 230. As already explained on the basis of FIG. 2, the partition wall 110 preferably has a permanent connection 151 to the piston 62, but it can also be installed without such a connection. In the radially inner area, the partition wall 110 is supported axially against the torsion damper hub 52 by means of a support bearing 239 and sealed off radially against the torsion damper hub 52 by sealing 160. It is especially advantageous for the partition wall 110 to exert an axial force toward the housing wall 20, thus to keep the piston 62 held against the housing wall 20 as long as no positive pressure is intentionally being built up in the drive-side pressure space 105 versus the hydrodynamic circuit 34. The partition wall 110 is preferably pretensioned in the axial direction.

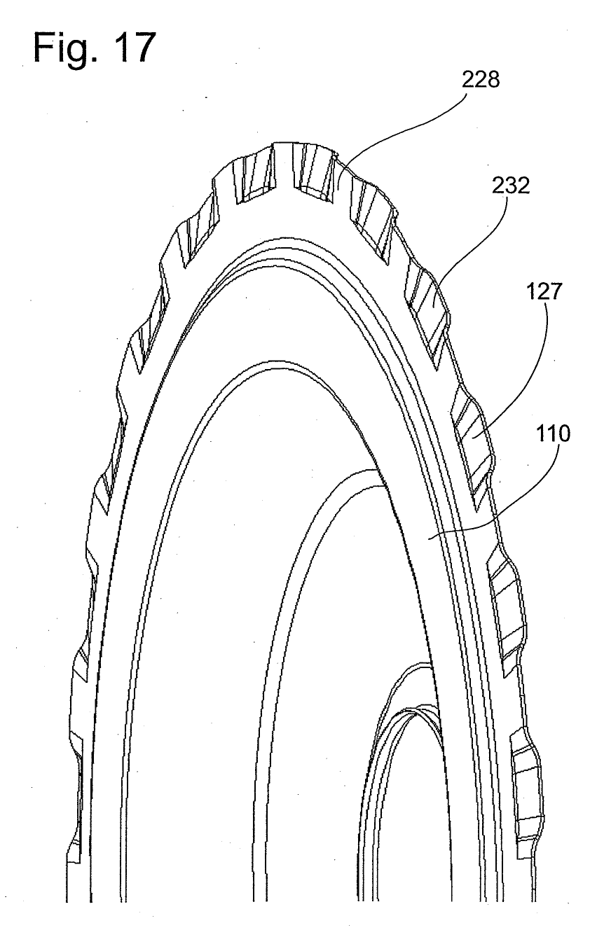

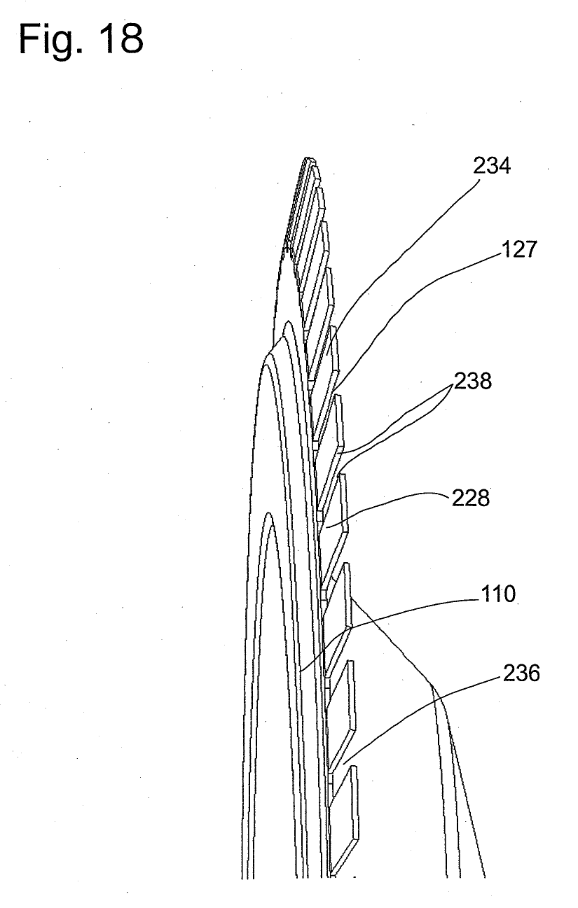

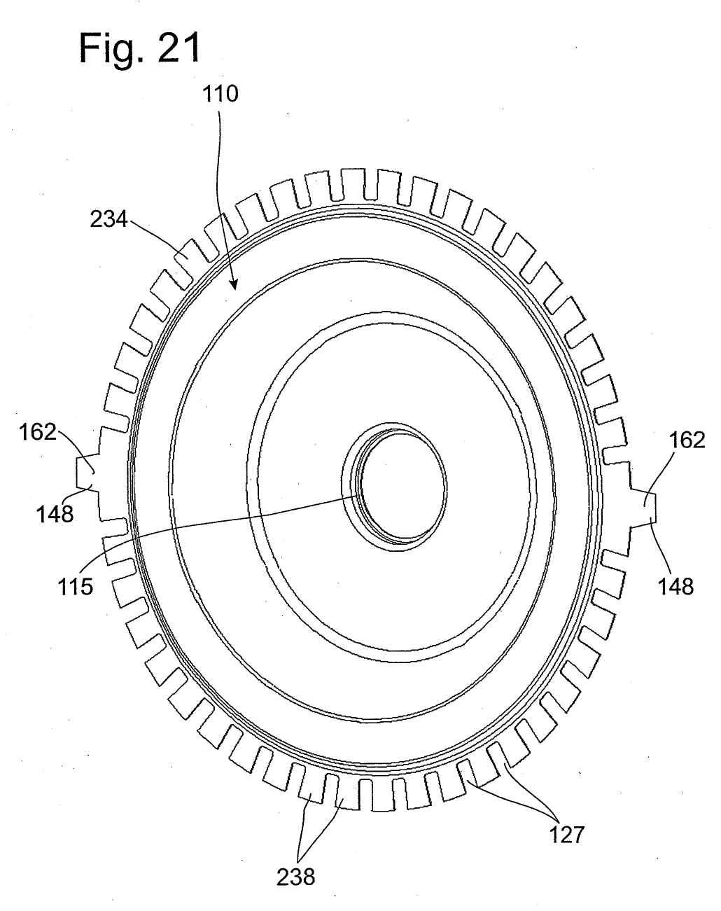

The partition wall 110 preferably has an integrated zone 228, a certain predetermined radial distance away from the axis of rotation 4 of the housing 5. This zone is provided, for example, in the radial area of the profiling 126 on the piston 62 and can be designed as a spring zone. This integrated zone 228 can, as FIG. 14 shows, be flat, or, according to FIG. 17, it can be provided with a wave-like profiling 232. According to FIG. 18 or FIG. 21, furthermore it could also be provided with an interrupted profiling 238. FIGS. 17 and 18 show details of the partition wall 110.

According to FIG. 17, the integrated zone 228 of the partition wall 110 is designed so that its axial distance from the piston 62 varies in alternating fashion around the circumference, so that the previously mentioned circumferential wave-like profiling 232 is formed. In contrast, FIG. 18 shows the integrated zone 228 of the partition wall 110 with radially outward-extending tongues 234, between which interruptions 236 in the partition wall 110 are present, so that the circumferentially interrupted profiling 238 is formed.

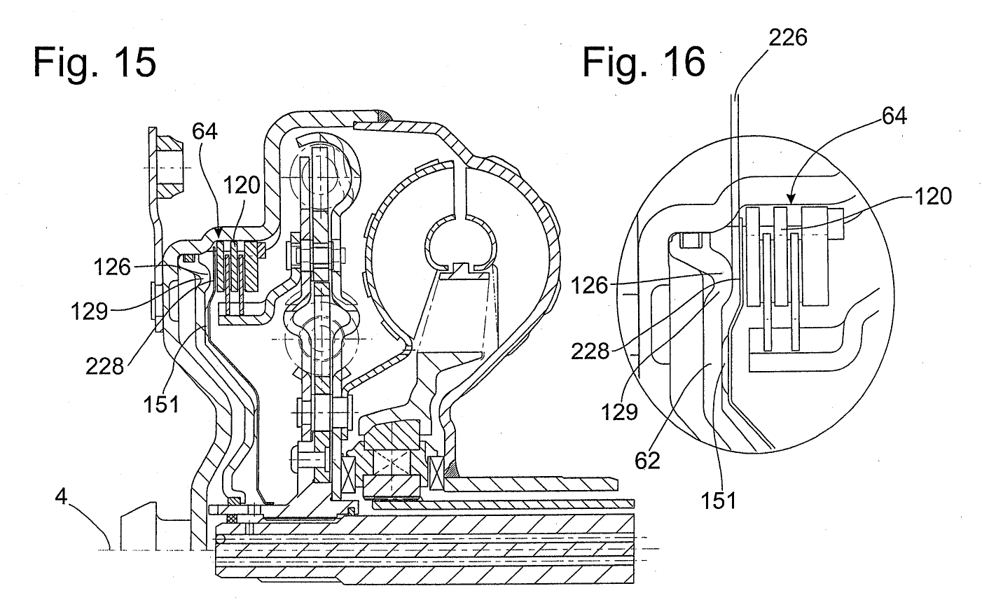

FIGS. 15 and 16 also show a partition wall 110, which acts as an axial spring 230. In contrast to the design of FIG. 14, the variant in FIGS. 15 and 16 has an axial gap 226 (FIG. 16) between the piston 62 and the partition wall 110 when the piston 62 is in a position in which the bridging clutch 64 is not producing a working connection between the drive side and the takeoff side of the clutch arrangement 3. As a result of this axial gap 226, the approach of the piston 62 to the clutch 120 has the initial effect of bringing the partition wall 110 into contact with the axially adjacent, radially outer clutch element 132; and, as the piston 62 approaches the clutch 120 even more closely, the partition wall 110 initially undergoes elastic deformation, which is associated with a simultaneous reduction in the width of the axial gap 226. This process continues until the gap is finally closed up completely. Until the axial gap 226 is closed completely, the partition wall 110 acts like a disk spring, during which phase the area between the axial support of the partition wall 110 against the site of the permanent connection 151 and the pressure area 129 of the piston 62 undergoes elastic deformation. In this phase of the build-up of a working connection between the drive side and the takeoff side of the clutch arrangement 3, the partition wall 110 therefore acts as mediating contact spring for the piston 62. Once the axial gap 226 has been completely closed, however, the present design functions in the same way as that shown in FIG. 14.

To return to FIGS. 17 and 18, the embodiments of the partition wall 110 shown here, as already discussed, have an integrated zone 228, which can be formed either on a partition wall 110 designed as an axial spring 230 or on a partition wall 110 with relatively high axial stiffness.

Independently of the axial stiffness selected in a specific case, each of the designs of the partition wall 110 according to FIGS. 17, 18, and 21 allows a type of flow guidance which deviates from that of the partition wall 110 of FIG. 2. That is, FIG. 2 shows the pressure area 129 of the piston 62 with a profiling 126 to form the integrated flow channels 127, whereas the partition wall 110, at least in the area of the pressure area 129 of the piston 62, is flat. In contrast, each of the embodiments of the partition wall 110 according to FIGS. 17, 18, and 21 make it possible to have a piston 62 with a flat pressure area 129, because these partition walls 110 are each provided with a profiling 232 or 238 to form the flow channels 127. In the case of FIG. 17, the flow channels 127 are created by the wave-like profiling 232; in the case of FIGS. 18 and 21, they are created by the circumferential interruptions 236 between the tongues 234 spaced around the circumference. The flow channels 127 are in flow connection with the flow passage 150 (FIG. 8), which is provided on the set of teeth 130 on the inside surface of the axial section 128 of the housing cover 20.

On the basis of the interrupted profiling 238, FIG. 21 shows the spatial and functional separation of the flow channels 127 from the set of teeth 148 of the partition wall 110 serving as the antitwist device 162. This set of teeth 148, as previously described, is connected for rotation in common to the set of teeth 130 on the inside surface of the axial section 128 of the housing cover 20.

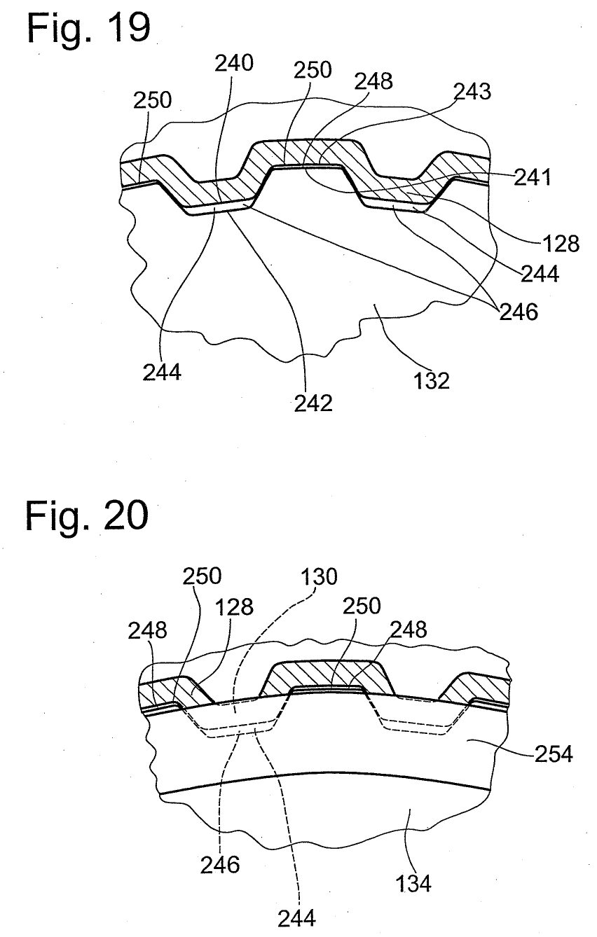

FIGS. 19 and 20, finally, show a route for the forced cooling of the clutch elements 132 and 138 of the clutch 120. For this purpose, the set of teeth 130 is formed on the axial section 128 of the housing 5 in such a way that, first, the teeth engage for rotation in common with the radially outer clutch elements 132 and with the last clutch element 134 at least essentially without any play in the circumferential direction, and, second, that the tooth tip areas 240 engage in the tooth root areas 242 of the radially outer clutch elements 132 and of the last clutch element 134. The tooth tip areas 240 of the set of teeth 130 on the axial section 128 of the housing 5 extend toward the assigned tooth root areas 242 of the associated radially outer clutch elements 132 and of the last clutch element 134, leaving a radial gap 244. Each of these radial gaps 244 serves as a flow passage 246 for the fluid medium.

In contrast, the tooth root areas 243 of the set of teeth 130 provided on the axial section 128 of the housing 5 engage at least essentially without radial gaps with the tooth tip areas 241 of the associated radially outer clutch elements 132 and of the last clutch element 134, because the tooth tip areas 241 extend at least essentially right up to the associated tooth root areas 243 of the set of teeth 130 and as a result form near-contacts 248, each of which serves as a flow obstacle 250 for the fluid medium.

The last clutch element 134 serves as an axial stop for the radially outer clutch elements 132 of the clutch 120 and is positioned axially with respect to the set of teeth 130 by a back-up ring 136, inserted into a circumferential groove 252 provided in the axial section 128 of the housing 5, especially provided in the set of teeth 130. Because of its engagement in the circumferential groove 252, the back-up ring 136 acts as a fluid seal 254, by which at least most of the fluid medium arriving through the flow passages 246 is prevented from leaving the cooling space 220. The fluid medium is therefore forced to flow through the cooling space and can leave it only after passing through the clutch elements 132 and 138, after which it can flow onward into the hydrodynamic circuit 34. Because of its action as a fluid seal 254, the back-up ring 136 therefore supports the function of the near-contacts 248, which, as previously mentioned, serve as flow obstacles 250.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. A fluid-filled clutch arrangement for installation between a drive and a takeoff, the arrangement comprising:
a housing;
a piston mounted with freedom of axial movement in the housing, the piston being sealed against the housing, the piston having a drive side bounding a drive side pressure space from a takeoff side bounding a takeoff side pressure space;
a clutch which can establish and release a working connection between the drive and the takeoff as a function of the position of the piston relative to the clutch;
a partition wall bounding the takeoff side pressure space opposite the piston, the partition wall being active between the takeoff side pressure space and a cooling space, wherein the partition wall is free to move axially relative to the piston; and
at least one supply line connected to a fluid supply source, said at least one supply line being connected to at least one of said drive-side pressure space, said takeoff side pressure space, and said cooling space.

2. The fluid-filled clutch arrangement of claim 1, wherein the clutch comprises a component adjacent to the partition wall, the partition wall remaining in contact with the component regardless of the axial position of the piston.

3. The fluid-filled clutch arrangement of claim 2, wherein the contact is maintained by a pressure gradient between the takeoff side pressure space and the cooling space.

4. The fluid-filled clutch arrangement of claim 1, wherein one of said partition wall and said piston is provided with spacers facing the other of said partition wall and said piston, said spacers creating flow channels between said partition wall and said piston.

5. The fluid-filled clutch arrangement of claim 1, wherein one of said piston and said partition wall has an axial profiling which creates flow channels between said partition wall and said piston.

6. The fluid-filled clutch arrangement of claim 1, wherein the partition wall has a radially outer area provided with an anti-twist device that prevents rotation of the partition wall relative to the housing.

7. The fluid-filled clutch arrangement of claim 6, wherein the anti-twist device acts as a flow passage.

8. The fluid-filled clutch arrangement of claim 1, further comprising an axial slide guide provided on one of said piston and said partition wall and an opening provided in the other of said piston and said partition wall, said axial slide guide being received in said opening to permit axial movement while preventing rotation of said piston relative to said partition wall.

9. The fluid-filled clutch arrangement of claim 1, further comprising a first supply line connected directly to said drive side pressure space, and one of a second supply line connected directly to said takeoff side pressure space and a first connection connecting the first supply line to the takeoff side pressure space.

10. The fluid-filled clutch arrangement of claim 1, further comprising a torsional vibration damper with a torsional vibration damper hub, wherein said piston and said partition wall are mounted on said torsion damper hub.

11. The fluid-filled clutch arrangement of claim 1, further comprising a drive side housing hub mounted on a housing cover, a torsional vibration damper with a torsion damper hub, and a positioning bearing between the housing hub and the torsion damper hub, wherein the piston and the partition wall are mounted on the drive side housing hub.

12. The fluid-filled clutch arrangement of claim 1, further comprising a seal between the partition wall and a hub on which it is mounted.

13. The fluid-filled clutch arrangement of claim 1, wherein the partition wall has radial profilings which bound flow channels extending circumferentially between the radial profilings.

14. The fluid-filled clutch arrangement of claim 1, wherein the partition wall is designed as an axial spring which exerts an axial force on the bridging clutch.

15. The fluid-filled clutch arrangement of claim 1, wherein the partition has a radially outer area provided with a wave-like profile having areas contacting the piston in alternating fashion circumferentially.

16. The fluid-filled clutch arrangement of claim 1, wherein the partition has a radially outer area provided with radially outward extending tongues alternating circumferentially with cutouts to form a circumferentially interrupted profile.

17. The fluid-filled clutch arrangement of claim 1, wherein the housing has an axial section provided with a set of radially extending teeth having tip areas separated by root areas, and the clutch comprises at least one radially outer clutch element with a set of radially extending teeth having tip areas separated by root areas, wherein the tip areas of the teeth on the housing extend into the root areas of the teeth of the radially outer clutch element to form radial gaps which serve as flow passages for the fluid.

18. The fluid-filled clutch arrangement of claim 17, wherein the tip areas of the teeth on the radially outer clutch element extend essentially all the way into the root areas of the teeth of the axial section of the housing to form flow obstacles for the fluid.
